(19) United States
(12) Patent Application Publication
(10) Pub. No.: US 2017/0262057 A1
(43) Pub. Date: Sep. 14, 2017

(54) METHOD FOR OPERATING A DISPLAY, DISPLAY DEVICE FOR A MOTOR VEHICLE, AND MOTOR VEHICLE HAVING A DISPLAY DEVICE

(71) Applicant: AUDI AG, Ingolstadt (DE)

(72) Inventors: Thomas KNITTL, Ingolstadt (DE); Jacques HÉLOT, Ingolstadt (DE)

(73) Assignee: AUDI AG, Ingolstadt (DE)

(21) Appl. No.: 15/128,363

(22) PCT Filed: Oct. 29, 2015
(86) PCT No.: PCT/EP2015/002145

§ 371 Date: Sep. 22, 2016

(30) Foreign Application Priority Data
Nov. 3, 2014 (DE) 10 2014 016 328.8

(51) Int. Cl. G06F 3/01; G06F 3/0488; B60K 35/00

(52) U.S. Cl. CPC G06F 3/016; B60K 35/00; G06F 3/0488; B60K 2350/1004; B60K 2350/1028; B60K 2350/405; G06F 2203/04809

(57) ABSTRACT

At least one display area is predefined in a touch-sensitive and flexible display of a display device. When the display is deformed in such a way that the predefined display area is distorted; an operator control element of a graphical user interface is displayed in the predefined display area.

### CROSS REFERENCE TO RELATED APPLICATIONS

This application is the U.S. national stage of International Application No. PCT/EP2015/002145, filed Oct. 29, 2015 and claims the benefit thereof. The International Application claims the benefit of German Application No. 10 2014 016 328.8 filed on Nov. 3, 2014, both applications are incorporated by reference herein in their entirety.

### BACKGROUND

Described below are a method for operating a display device of a motor vehicle, to a display device for a motor vehicle and a motor vehicle having such a display device.

Touch-sensitive screens, that is to say touchscreens, are being increasingly used in motor vehicles. Making such touchscreens safe to operate by a driver while he is driving a motor vehicle presents significant challenges to motor vehicle manufacturers. This is because compared with operator control using, for example, a conventional button which the driver can operate even without looking at it, the operation of a touchscreen also requires in most cases the driver to direct his gaze at the touchscreen in order to find virtual operator control elements which are displayed on the touchscreen and then be able to correspondingly operate the elements.

DE 10 2005 049 127 A1 presents a flexible display behind which there are switching elements which can be used to make available haptic feedback as soon as pushbuttons which are displayed above the switching elements by the display are touched. In addition there is provision that the display is provided, at least in certain areas, with a texture which can be sensed haptically. Furthermore, the flexible display can also have depressions, with the result that, for example, a driver can use his finger to intuitively find an operator control point by feeling these depressions.

DE 10 2012 024 949 A1 presents a display device for a vehicle having a distorted display face. The display face has a touch-sensitive operator control section in the distorted area.

DE 10 2010 010 575 A1 presents a display device for a motor vehicle having a flexible display panel. The display panel is covered by a transparent layer which has relief-like structures for facilitating the operator control.

### SUMMARY

The method facilitates blind operator control capability of a touch-sensitive display device within a motor vehicle.

Described below is a method for operating a display device and a motor vehicle having a display device.

In the method, at least one display area is predefined within a touch-sensitive and flexible display of the display device. The display is deformed in such a way that the predefined display area is distorted. An operator control element of a graphical user interface is displayed in the predefined display area of the display.

In other words, a flexible display may be deformed in at least one predefined display area in such a way that the predefined display area has a shape which can be sensed or felt haptically, wherein at least one virtual operator control element of a graphical user interface is displayed in the predefined display area of the display, that is to say at least after the deformation of the display in the distorted display area. As a result, virtually a blind operator control of a touch-sensitive display device is made possible. In other words, the display is therefore bent or deformed in some other way at at least one point or else at a plurality of points, with the result that in the at least one display area a contour is made available which can be felt, in particular, by a driver of the motor vehicle and in which the at least one operator control element of the graphical user interface is displayed. In particular, a driver can find the operator control element and activate it without having to direct his gaze onto the display, for example with his finger. The distraction of a driver from the events on the road when driving the motor vehicle is therefore considerably reduced. An intelligent use of actual changes in the contour or shape at the display in combination with the displaying of virtual operator control elements is therefore made possible. The display device can for this purpose have corresponding adjustment devices by which the display device is deformed in the predefined display area actually by applying mechanical force to the display. Alternatively, it is, for example, also possible for the adjustment device to supply a partial vacuum, as a result of which the predefined display area is correspondingly deformed mechanically.

In one advantageous refinement of the method a first part of the display is bent in the direction of a second part of the display, and as a result the display area which is arranged between the two parts of the display is embodied in the form of a bending edge. However, in this case, the word bending edge should not necessarily be understood in the strictly mathematical sense but instead the bending edge already has a certain distortion into which a driver can place his finger and move it along the bending edge. In this case the operator control element may be displayed in the form of a virtual sliding ruler by which a driver can, for example, adjust the temperature or adapt the volume of the sound or the like.

In a further advantageous embodiment of the method, the display area or another display area is distorted in such a way that the display area is embodied as a depression in the display. The depression can have essentially any desired shape. For example, the depression can be embodied as a type of dent, trough, in the form of a hemisphere or the like. In the event of the display area being embodied as a depression in the display, the operator control element may be displayed in the form of a pushbutton. In particular, the driver of the motor vehicle can therefore particularly easily feel the depression with his finger without having to direct his gaze onto the display, and can therefore reliably operate the operator control element blind.

In a further advantageous refinement of the method, the display area is not distorted until it is detected that a user touches the display with a finger. For example, a driver can place his finger on the display, as a result of which the predefined display area is subsequently distorted. The driver can move his finger over the display and feel the distortion formed within the display area and can then activate blind the operator control element which is displayed there. An advantage of this procedure is that the visual appearance of the display is not adversely affected by distortions, for example depressions, which are formed permanently within the display, and the display area is deformed only according to requirements.

According to a further advantageous embodiment, the distortion of the display area is reversed as soon as it is detected that the user has removed his finger from the distorted display area. This also contributes, in particular, to the fact that the visual appearance of the display appears particularly advantageously in the cases in which a user does not touch the display at all.

In a further advantageous embodiment, the display area is distorted as soon as the operator control element is displayed. The advantage is that a user can operate the operator control element in any case without having to direct his gaze onto the display device. In this context, as soon as it is detected that a user touches the curved display area with a finger, the distortion of the display area which has been formed until then may be increased by a predefined amount. As a result, the grip which a user experiences with his finger in the display area is enhanced further. The enhanced distortion of the display area may be reversed again as soon as it is detected that a user has removed his finger from the display area.

According to a further advantageous embodiment, the position of the display area and the shape of the distortion of the display area are predefined as a function of the graphical user interface which is displayed on the display. The flexible display is therefore deformed in such a way that distortions which can be felt by the driver are formed at the points of the display at which the display displays operator control elements in accordance with the currently displayed graphical user interface. Furthermore, the geometric embodiment of the curvature is correspondingly predefined in accordance with what types of operator control elements the graphical user interface displays, for example virtual pushbuttons or virtual sliding regulators. In other words, the display is always deformed as a function of which operator control elements are currently being displayed with a corresponding graphical user interface, with the result that the distortions which can be felt by a vehicle occupant are formed for the currently displayed operator control elements within the flexible display. The shaping of the display is therefore adapted in each case to the currently displayed graphical user interface in such a way that the virtual operator control elements of the graphical user interface can be felt, in particular by a driver, particularly easily without him directing his gaze towards the display.

In a further advantageous refinement a plurality of display areas are predefined and distorted, wherein the number and respective positions of the display areas and the shape of the respective distortion of the display areas are predefined as a function of the graphical user interface which is displayed on the display. In other words, a plurality of distortions or deformations within the display can therefore be formed depending on how many, and what types of, virtual operator control elements of a graphical user interface are currently being displayed on the display.

The display device for a motor vehicle described herein has a touch-sensitive and flexible display. Furthermore, the display device includes an adjustment device which is designed to deform the display in such a way that at least one display area within the display is distorted. In addition, the display device also includes a control device which is designed to predefine the at least one display area within the display and to actuate the display to display an operator control element of a graphical user interface in the predefined display area. Advantageous refinements of the method are to be considered to be advantageous refinements of the display device, wherein the display device, in particular, carries out the method.

The motor vehicle contains the display device.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a motor vehicle with a display device which has a touch-sensitive and flexible display, an adjustment device and a control device;

FIG. 2 is a perspective view of the touch-sensitive and flexible display, wherein the display is arranged in the region of a central tunnel of the motor vehicle and part of the display is bent upwards;

FIG. 3 is a schematic sectional view through the display device, wherein a plurality of adjustment elements are arranged underneath the touch-sensitive and flexible display;

FIG. 4 is a further sectional view through the display device, wherein troughs have been formed in two display areas by the adjustment elements; and

FIG. 5 is a partial perspective view of the touch-sensitive and flexible display, wherein a part of the display is again bent upward, and the troughs are formed in the upwardly bent part of the display.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

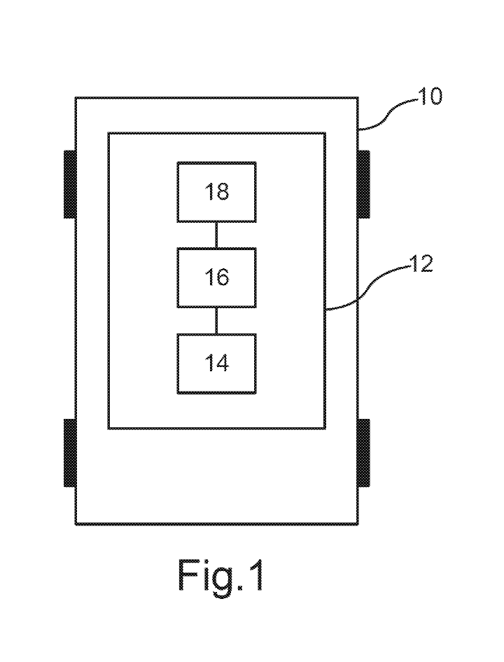

A motor vehicle 10 is shown in a schematic illustration in FIG. 1. The motor vehicle 10 includes a display device 12 which has a touch-sensitive and flexible display 14, an adjustment device 16 and a control device 18. The display 14 is, in other words, a flexibly deformable touchscreen. The display 14 and very different functions of the motor vehicle 10 can therefore be controlled by correspondingly touching the display 14.

The adjustment device 16 is designed to deform the display 14 in such a way that at least one display area within the display 14 is distorted. The control device 18 is designed to predefine the at least one display area within the display 14 and to actuate the display 14 to display an operator control element (not illustrated here) of a graphical user interface in the predefined display area.

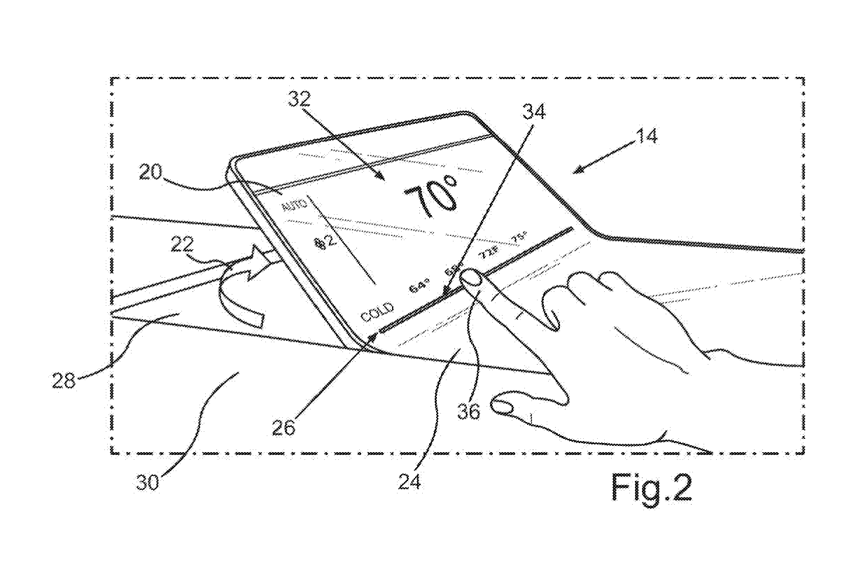

FIG. 2 illustrates a possible embodiment of the display 14. A first part 20 of the display 14 has been bent in the direction wherein the arrow 22, in the direction of a second part 24 of the display 14, as a result of which a display area 26 with a bending edge has been formed between the two parts 20, 24 of the display 14. The first part 20 of the display 14 has therefore been bent upward from a receptacle 28 or a depression, wherein the display 14 is arranged in the region of a central tunnel 30 of the motor vehicle 10.

In the example shown here, the display 14 displays a graphical user interface 32 by which the temperature of an air conditioning system of the motor vehicle 10 can be set. An operator control element 34, which is embodied as a type of virtual sliding regulator, is displayed within the display region 26 which is embodied in the form of a bending edge.

A driver of the motor vehicle 10 can place his finger 36 on the operator control element 34 without having to direct his gaze onto the display 14, since the operator control element 34 is arranged in the distorted display area 26, that is to say in the region of the bending edge which is formed between the two parts 20, 24 of the display 14.

Contrary to the example shown in FIG. 2, the display 14 can, for example, also be embodied as a planar display, wherein at least the one display area 26 is distorted in such a way that the display area 26 is embodied as a depression in the display 14. In other words, for example a dent, a trough, a hemispherical depression or the like in which an operator control element 34 of the graphical user interface 32 is to be displayed can be formed within the display 14, with the result that a driver can feel this depression quite easily with his finger 36, so that he does not have to direct his gaze onto the display 14 in order to activate the respective operator control element 34 of the graphical user interface 34 which is currently being displayed.

In this context it is possible to provide that the respective display area 26 is not distorted until it is detected that a user has placed his finger 36 on the display 14. The distortion of the display area 26 is then reversed again as soon as it is detected that the user has removed his finger 36 from the distorted display area 26 again.

Alternatively it is also possible that the display area 26 is distorted as soon as the respective operator control element 34 of the graphical user interface 32 is displayed. As soon as it is then detected that, for example, the driver touches the distorted display area, and therefore the displayed operator control element 34, with his finger 36, the distortion of the display area 26 which has been formed until then is increased by a predefined amount, with the result that the driver experiences even additional grip with his finger 36 when he activates the operator control element 34. The increased distortion of the display area 26 may be reversed again as soon as it is detected that the driver has moved his finger 36 from the display area 26.

The position of the display area 26 and the shape of the distortion of the display area 26 may be predefined as a function of the graphical user interface 32 displayed on the display 14. In other words, the flexible display 14 is therefore always deformed according to requirements in such a way that currently displayed operator control elements 34 of the graphical user interface are displayed in distorted areas of the display 14, that is to say, for example, at bending edges, trough-shaped depressions or the like. Therefore, in particular, the driver of the motor vehicle 10 can operate corresponding virtual operator control elements 34 blind with his finger 36, since he can feel the operator control elements 34 owing to the distortions formed in the display 14.

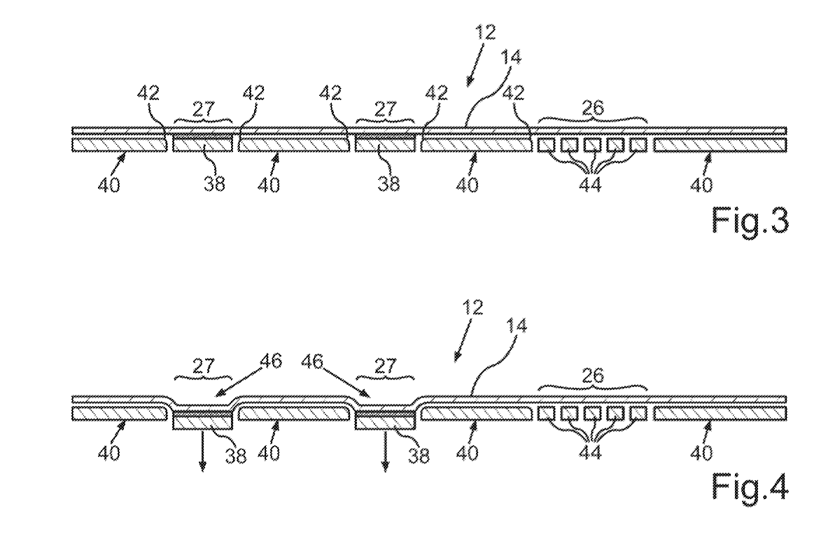

In FIG. 3, the display device 12 is shown in a schematic lateral sectional view. Underneath the flexible display 14 a plurality of adjustment elements 38 are arranged which are part of the adjustment device 16 shown schematically in FIG. 1. The adjustment elements 38 are arranged here underneath further predefined display areas 27 of the display 14. Furthermore, a carrier 40, in the recesses (not shown) of which the adjustment elements 38 are arranged is arranged underneath the flexible display 14. The carrier 40 is provided here with rounded portions 42 in the region adjoining the adjustment elements 38. In addition, the carrier 40 also has segmented carrier elements 44, so that the distortion of the display 14 explained in conjunction with FIG. 2 between the two display parts 22, 24 can easily be formed.

FIG. 4 shows the display device 12 again in a schematic lateral sectional view, wherein respective troughs 46 have been formed in the region of the further display areas 27 by the adjustment elements 38. The adjustment elements 38 are connected to the display areas 27 and are moved away from the display 14—that is to say are moved downward in the present illustration—in order to form the troughs 46. As a result of the fact that the adjustment elements 38 are connected, for example bonded, to the display areas 27, the display areas 27 are deflected in relation to the rest of the display 14, that is to say are moved downward together with the adjustment elements 38 in accordance with the present illustration. Then, operator control elements 34 (not illustrated here) are in turn displayed in the troughs 46, with the result that, in particular, in order to activate the operator control elements 34 a driver simply has to feel the troughs 46 without having to direct his gaze onto the display.

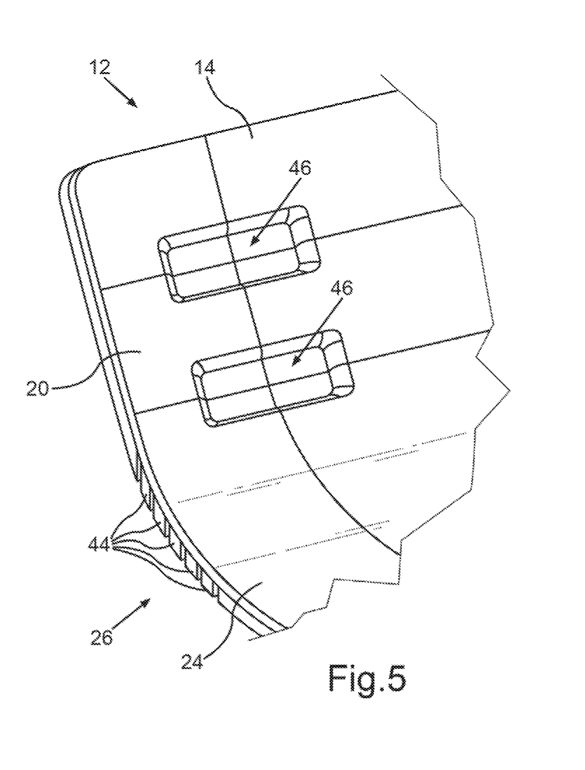

FIG. 5 shows the display 14 in a perspective view, wherein again the first part 20 of the display 14 is, as illustrated in FIG. 2, bent upward and the troughs 46 are formed in the upwardly bent part 20 of the display 14.

Overall, the display device 12 and the explained method for operating the display device 12 permits a particularly good blind operating capability of a touchscreen, since corresponding depressions, bulges or the like are formed on the flexible display 14 in such a way that, in particular, a driver can feel them with his finger 36. As a result, the frequency and the duration with which, in particular, a driver has to direct his gaze onto the touch-sensitive display 14 to operate the display 14 are reduced, at least to a considerable degree. As a result, the safety when driving the motor vehicle 10 can be considerably improved.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for operating a display device of a motor vehicle, comprising:
predefining at least one display area within a display of the display device, having a touch-sensitive surface and a flexible structure;
deforming the display so that the at least one display area is distorted; and
displaying an operator control element of a graphical user interface in the at least one display area of the display.

12. A method according to claim 11, wherein said deforming includes bending a first part of the display towards a second part of the display, so as to form a curved part in the at least one display area between the first and second parts of the display.

13. A method according to claim 11, wherein said deforming includes forming a depression in the at least one display area of the display.

14. A method according to claim 11,
further comprising detecting a user touch of the touch-sensitive surface of the display, and
wherein the at least one display area is not distorted until the user touch of the display with a finger is detected.

15. A method according to claim 14,
wherein said detecting detects the user touch in the at least one display area, and
wherein said method further comprises reversing said deforming of the at least one display area when said detecting detects that the finger of the user has been removed from the at least one display area.

16. A method according to claim 11, wherein said deforming of the display is performed contemporaneously with said displaying of the operator control element.

17. A method according to claim 11, wherein said predefining includes a position of the at least one display area and a shape of distortion of the at least one display area in dependence upon the graphical user interface displayed on the display.

18. A method according to claim 11,
wherein the at least one display area includes a plurality of display areas, predefined and distorted, and
wherein said predefining includes a number, respective positions and a shape of respective distortions of the display areas, as a function of the graphical user interface displayed on the display.

19. A display device for a motor vehicle, comprising:
a display with a touch-sensitive surface and a flexible structure;
an adjustment device configured to deform the display so that at least one display area within the display is distorted;
a controller configured to predefine the at least one display area within the display and to actuate the display to display an operator control element of a graphical user interface in the at least one display area.

20. A display device according to claim 19, wherein said adjustment device bends a first part of the display towards a second part of the display, so as to form a curved part in the at least one display area between the first and second parts of the display.

21. A display device according to claim 19,
further comprising a detector configured to detect a touch by a finger of a user on the touch-sensitive surface of the display, and
wherein said adjustment device distorts the at least one display area after the touch on the touch-sensitive surface of the display is detected.

22. A display device according to claim 21,
wherein said detector detects the touch in the at least one display area, and
wherein said adjustment device reverses distortion of the at least one display area when said detector detects that the finger of the user has been removed from the at least one display area.

23. A display device according to claim 19, wherein said controller predefines a position of the at least one display area and a shape of distortion of the at least one display area in dependence upon the graphical user interface displayed on the display.

24. A display device according to claim 19,
wherein the at least one display area includes a plurality of display areas, predefined and distorted, and
wherein said controller predefines a number, respective positions and a shape of respective distortions of the display areas, as a function of the graphical user interface displayed on the display.

25. A motor vehicle, comprising:
a chassis; and
a display device including
a touch-sensitive and flexible display;
an adjustment device configured to deform the display so that at least one display area within the display is distorted;
controller configured to predefine the at least one display area within the display and to actuate the display to display an operator control element of a graphical user interface in the at least one display area.

26. A motor vehicle according to claim 25, wherein said adjustment device bends a first part of the display towards a second part of the display, so as to form a curved part in the at least one display area between the first and second parts of the display.

27. A motor vehicle according to claim 25,
further comprising a detector configured to detect a touch by a finger of a user on the touch-sensitive surface of the display, and
wherein said adjustment device distorts the at least one display area after the touch on the touch-sensitive surface of the display is detected.

28. A motor vehicle according to claim 27,
wherein said detector detects the touch in the at least one display area, and
wherein said adjustment device reverses distortion of the at least one display area when said detector detects that the finger of the user has been removed from the at least one display area.

29. A motor vehicle according to claim 25, wherein said controller predefines a position of the at least one display area and a shape of distortion of the at least one display area in dependence upon the graphical user interface displayed on the display.

30. A motor vehicle according to claim 25,
wherein the at least one display area includes a plurality of display areas, predefined and distorted, and
wherein said controller predefines a number, respective positions and a shape of respective distortions of the display areas, as a function of the graphical user interface displayed on the display.
